(19) United States
(12) Patent Application Publication
(10) Pub. No.: US 2015/0167976 A1
(43) Pub. Date: Jun. 18, 2015

(54) LIGHTER

(71) Applicant: VMR Products, LLC, Miami, FL (US)

(72) Inventor: Dan Recio, Miami, FL (US)

(73) Assignee: VMR Products, LLC, Miami, FL (US)

(21) Appl. No.: 14/569,058

(22) Filed: Dec. 12, 2014

Related U.S. Application Data
(60) Provisional application No. 61/915,204, filed on Dec. 12, 2013.

(51) Int. Cl. F23Q 7/16; G06F 1/18

(52) U.S. Cl. CPC F23Q 7/16; G06F 1/182

(57) ABSTRACT

A lighter may include a shell, a power source disposed within the shell, a coil in electrical communication with the power source, and a cover movable between an open and a closed position, with the coil exposed to the environment in the open position and shielded from the environment in a closed position. When the lighter is opened, by sliding the cover for instance, the an electrical current may flow through the coil thereby heating the coil to a temperature sufficient to ignite a combustible object, such as a cigarette. The power source may be a rechargeable battery.

### CROSS REFERENCE TO RELATED APPLICATIONS

This application claims the benefit of U.S. Provisional Application No. 61/915,204 filed Dec. 12, 2013, the disclosure of which is hereby incorporated herein by reference in its entirety. This application is also related to U.S. Design Application No. 29/483,487 filed Feb. 28, 2014, and U.S. Design Application No. 29/483,492 filed Feb. 28, 2014, the disclosures of which are hereby incorporated herein by reference in their entirety.

### FIELD OF THE DISCLOSURE

This invention relates in general to lighters for igniting a combustible material, such as a cigar or cigarette.

### BACKGROUND

Cigars and cigarettes are well known to be comprised of dried tobacco leaves mixed with other combustible substances and rolled into a cylindrical shape. In order to smoke a cigarette, a smoker will affix their lips around one end of the cigarette and suck air through the cigarette while a heat source is placed on the other end of the cigarette. As the opposite end of the cigarette combusts, the user will draw in smoke combusted from the heat source. Typically, the cigarette will remain lit after exposure to the heat source and the user may continue to draw in smoke after the heat source has been removed.

Heat sources for igniting cigarettes are typically matches or lighters. A lighter may refer to any portable device which provides a heat source to ignite a combustible material. Common lighters, for instance, are small enough to fit in the hand of a user and include a bottle or reservoir filled with a flammable fluid, a controlled means for releasing the flammable fluid, and a material such as flint for creating a spark which will ignite the fluid thereby generating a flame from which the combustible material may be lit from.

### BRIEF SUMMARY OF THE DISCLOSURE

The following presents a simplified summary of the invention in order to provide a basic understanding of some aspects of the invention. This summary is not an extensive overview of the invention. Rather than specifically identify key or critical elements of the invention or to delineate the scope of the invention, its purpose, inter alia, is to present some concepts of the invention in a simplified form as a prelude to the more detailed description that is presented later.

In one embodiment of the disclosure, a lighter is provided including a shell having opposed first and second ends; a power source disposed within the shell; a coil provided proximate to the first end of the shell, the power source in electrical communication with the coil in order to drive a current through the coil thereby heating the coil; and a cap positionable proximate to the first end of the shell and movable between closed position and an open position, the closed position substantially covering the coil from the environment and the open position exposing at least a portion of the coil to the environment thereby permitting a user of the lighter to press a combustible object against the coil in order to ignite the combustible object.

The power source may be a recharagable battery. The lighter may further includea port provided proximate the second end of the shell and in electrical communication with the rechargeable battery, the port connectable with an exterior power source in order to recharge the recharagable battery. The port may be a USB port and the exterior power source may be a personal computer. A memory feature may be included for storing digital information from the personal computer through the USB port. The port may be movable between a retracted position and a deployed position, with the port disposed within the shell in the retracted position and extending out and away from the shell in the extended position. The cover may connected to the shell at a hinge. The cover may also be substantially planar and slidable between the open and closed positions. A switch may be disposed within the shell, and the switch may be operable to drive a current flow from the power source through the coil thereby activating the lighter when the cap is opened. The coil may be comprised of a nichrome wire. The coil may glow a red or orange color when the lighter is activated. The lighter my further include an integrated circuit in electrical communication with the power source and the coil. The lighter may further comprise an illuminable indicator in electrical communication with the power source. The indicator may be an LED visible from outside the shell. The combustible object may be a cigarette.

### BRIEF DESCRIPTION OF THE FIGURES

The following description and the annexed drawings set forth certain illustrative aspects of the invention. These aspects are indicative of but a few of the various ways in which the principles of the invention may be employed and the present invention is intended to include all such aspects and their equivalents. Other advantages and novel features of the invention will become apparent from the following detailed description of the invention when considered in conjunction with the drawings.

FIG. 1 is a front perspective view of an embodiment of a lighter in a closed position in accordance with the disclosure;

FIG. 2 is a front perspective view of the lighter of FIG. 1 between an open and a closed position;

FIG. 3 is a front perspective view of the lighter of FIG. 1 in an open position;

FIG. 4 is a front cut-away view illustrating the internal components of the lighter of FIG. 1;

FIG. 5 is a front perspective view of the lighter of FIG. 1 in a retracted charging position;

FIG. 6 is a front perspective view of the lighter of FIG. 1 in a deployed charging position;

FIG. 7 illustrates an embodiment of a lighter connected to a USB port of a personal computer in accordance with the disclosure;

FIG. 8 illustrates an embodiment of a lighter in use in accordance with the disclosure; and

FIG. 9 illustrates an embodiment of a circuitry configuration for a printed circuit board in accordance with the disclosure.

### DETAILED DESCRIPTION OF THE DISCLOSURE

The following detailed description and the appended drawings describe and illustrate exemplary embodiments of the disclosure solely for the purpose of enabling one of ordinary skill in the relevant art to make and use the invention. As such, the detailed description and illustration of these embodiments are purely exemplary in nature and are in no way intended to limit the scope of the invention, or its protection, in any manner. It should also be understood that the drawings may not be to scale and in certain instances details may have been omitted, which are not necessary for an understanding of the present invention, such as conventional details of fabrication and assembly. These embodiments, which are also referred to herein as “examples,” are described in sufficient detail to enable those skilled in the art to practice the subject matter disclosed herein. It is to be understood that the embodiments may be combined or that other embodiments may be utilized, and that structural, logical, and electrical variations may be made without departing from the scope of the subject matter disclosed herein. The following detailed description is, therefore, not to be taken in a limiting sense, and the scope of the subject matter disclosed herein is defined by the appended claims and their equivalents.

Throughout the disclosure, the terms “a” or “an” may refer to one or more than one. In this document, the term “or” is used to refer to a nonexclusive or, unless otherwise indicated. Furthermore, references to “one embodiment” are not intended to be interpreted as excluding the existence of additional embodiments that also incorporate the recited features. Moreover, unless explicitly stated to the contrary, embodiments “comprising,” “including,” or “having” an element or a plurality of elements having a particular property may include additional such elements not having that property.

The following presents a simplified summary of the invention in order to provide a basic understanding of some aspects of the invention. This summary is not an extensive overview of the invention. Rather than specifically identify key or critical elements of the invention or to delineate the scope of the invention, its purpose, inter alia, is to present some concepts of the invention in a simplified form as a prelude to the more detailed description that is presented later.

In one embodiment of the disclosure, a lighter is provided including a shell having opposed first and second ends; a power source disposed within the shell; a coil provided proximate to the first end of the shell, the power source in electrical communication with the coil in order to drive a current through the coil thereby heating the coil; and a cap positionable proximate to the first end of the shell and movable between closed position and an open position, the closed position substantially covering the coil from the environment and the open position exposing at least a portion of the coil to the environment thereby permitting a user of the lighter to press a combustible object against the coil in order to ignite the combustible object.

The power source may be a recharagable battery. The lighter may further includea port provided proximate the second end of the shell and in electrical communication with the rechargeable battery, the port connectable with an exterior power source in order to recharge the recharagable battery. The port may be a USB port and the exterior power source may be a personal computer. A memory feature may be included for storing digital information from the personal computer through the USB port. The port may be movable between a retracted position and a deployed position, with the port disposed within the shell in the retracted position and extending out and away from the shell in the extended position. The cover may connected to the shell at a hinge. The cover may also be substantially planar and slidable between the open and closed positions. A switch may be disposed within the shell, and the switch may be operable to drive a current flow from the power source through the coil thereby activating the lighter when the cap is opened. The coil may be comprised of a nichrome wire. The coil may glow a red or orange color when the lighter is activated. The lighter my further include an integrated circuit in electrical communication with the power source and the coil. The lighter may further comprise an illuminable indicator in electrical communication with the power source. The indicator may be an LED visible from outside the shell. The combustible object may be a cigarette.

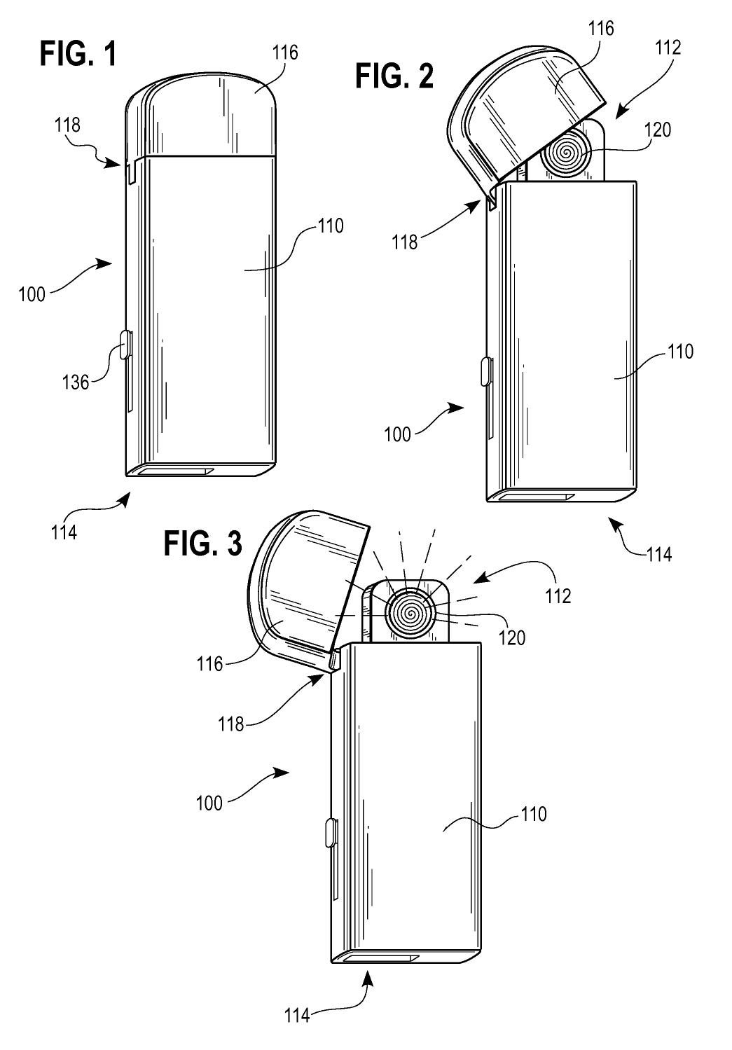

With reference now to FIGS. 1-6, an embodiment of a lighter 100 includes a body or outer shell 110 having a heating coil 120 provided on or proximate to a portion of outer shell 110 such that at least a portion of coil 120 is exposed to the environment in order to enable the placement of a cigar or cigarette onto coil 120. In the illustrated embodiment, shell 110 is longitudinally elongate with coil 120 provided in a portion of shell 110 extending from a first end 112 of shell 110. As shown in the illustrated embodiment, a cap 116 may be provided to cover first end 112 and coil 120. Cap 116 may be separable from shell 110 or, as is the case in the illustrated embodiment, may be connected to shell 110 at a hinge 118 in a flip top style. As discussed further herein, cap 116 or hinge 118 may be associated with other components of lighter 100 such that when cap 116 is removed, thereby exposing coils 120 to the environment, lighter 100 is automatically activated. It should be understood and appreciated by those of ordinary skill in the art that although coil 120 is shown in the illustrated embodiment as substantially collinear in the longitudinal direction with shell 110, the disclosure contemplates a variety of positions of coil 120 so long as a portion of coil 120 is exposed or exposable to the environment, and coil 120 is able to function in accordance with the disclosure. For instance, shell 110 may be bent or angled as opposed to elongate, or coil 120 may extend at an angle from the side of shell 110.

Provided on or within shell 110 is a battery or power source 130 in electrical communication with coil 120 in order to generate a current through coil 120. In the illustrated embodiment, power source 130 is a lithium ion battery pack encapsulated by shell 110 and rechargeable through a USB port 132 provided on an end of shell 110 opposite of coil 120. Other known or to be discovered rechargeable batteries, as well as other known or to be discovered means for recharging a rechargable battery are contemplated within the disclosure. Power source 130 is also contemplated within the disclosure as comprising one or more standard, household batteries, of AA or AAA size for example, so long as the batteries provide a sufficient current to heat coil 120 in accordance with the disclosure. As shown in the illustrated embodiment, power source 130 may be secured within shell 110 and inaccessible by a user. Alternatively, power source 130 may be provided in an externally attached housing, as opposed to disposed or encapsulated by shell 110.

Coil 120 may be composed of a conductive material, such as nichrome wire. Coil 120 may additionally, or alternatively, be composed of other metals, alloys, or conductive materials such as a nickel, chromium, or iron alloy, so long as coil 120 has a sufficiently high electrical resistance to sufficiently elevate the temperature of coil 120 in order to combust a cigarette as a current provided by power source 130 passes through the material of coil 120. In some embodiments, such as those utilizing a nichrome wire, coil 120 will glow a red or orange color as a current is passed through the coil 120, thereby serving as a visual indication that coil 120 is hot. It should also be appreciated that, although coil 120 is provided in a spiral arrangement in order to increase the surface area of the exposed wire, other shapes or arrangements, such as circles or polygons for instance, are contemplated within the disclosure. The utilization of multiple wires, as opposed to a single wire, is further contemplated within the disclosure.

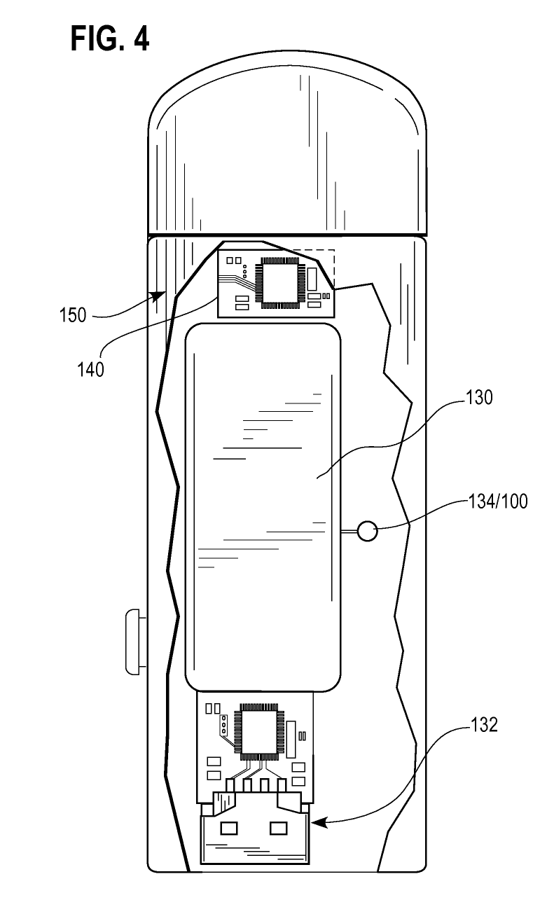

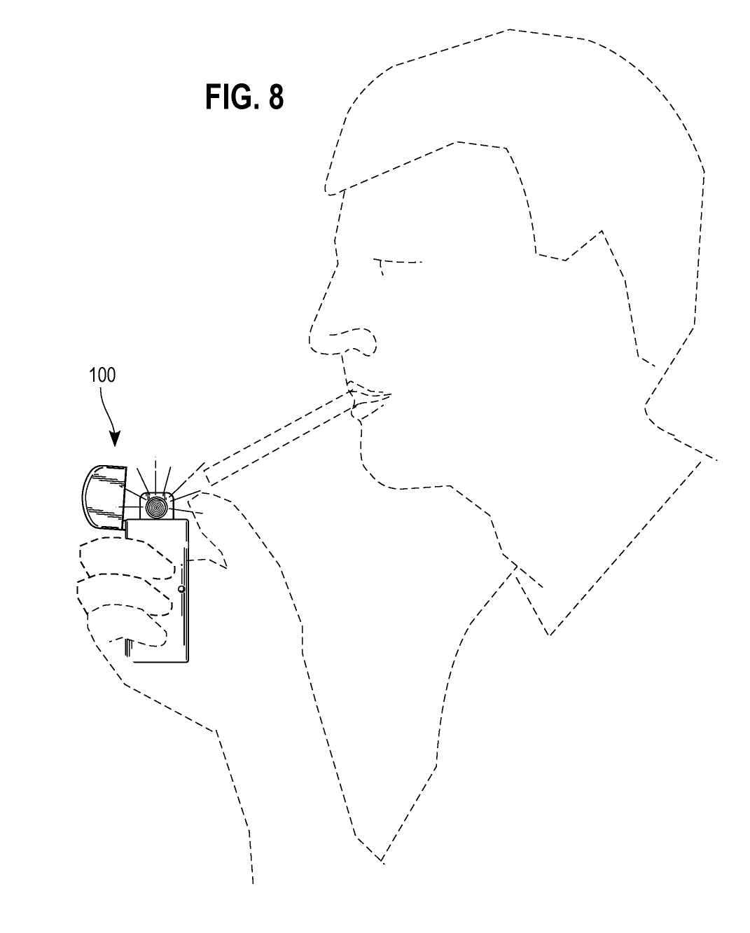

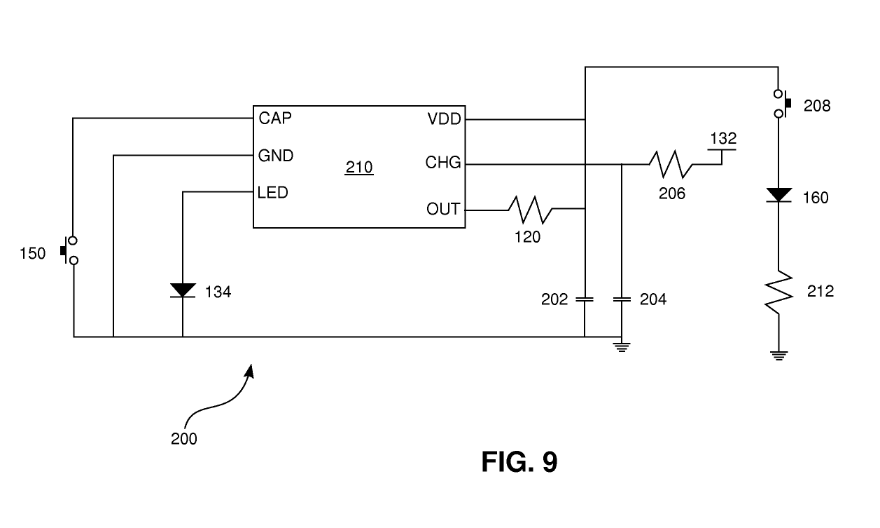

With primary reference now to FIGS. 4 and 9, provided on or within shell 110 is a printed circuit board (PCB) 140 having circuitry 200 comprising a variety of electronic components and connections for controlling various functions of lighter 100, as described herein. Activation of the lighter, meaning an initiation of a current flow from power source 110 into coil 120 so as to generate heat in coil 120, may be initiated through a switch 150. In embodiments including cap 116, switch 150 may be integrated into cap hinge 118 such that moving cap 116 from a closed position to an open position activates lighter 100. Switch 150 may be internally displaced within shell 110 so that it is mechanically actuated by the opening of hinge 118, as illustrated for instance between FIG. 2 and FIG. 3. FIG. 8 also illustrates a user of lighter 100 holding and using lighter 100 in accordance with the disclosure. Regardless if the actuation of switch 150 occurs from an opening the cap or from another manual or automatic action, the actuation may thereby close switch 150 within the circuitry of the lighter as shown, for instance, in the illustrated embodiment of circuitry 200.

Included in circuitry 200 is an integrated circuit (IC) 210, which in one embodiment may be an XM7100 monolithic IC. IC 210 may provide a high integration system or means for mutually incorporating function control of lighter 100, charging for power source 130, and a metal-oxide-semiconductor field-effect transistor (MOSFET). In order to be integrated within shell 110, IC 210 should be of a sufficiently small size to fit within shell 110, and in one embodiment IC 210 may be packaged in an SOT23-6L model or type. The wide operating voltage may be in a range from 2.5V to 5.5V, with a low quiescent current less than 5 uA and a high output current at approximately 1.5 A. Other IC 210 units are contemplated within the disclosure having features or components which perform the functions required by circuitry 200.

Circuitry 200 may further include capacitors 202, 204 which may be provided to stabilize or filter power source 150 and ground voltages as well as shunt any transient voltage spikes to prevent overvoltage spikes to IC 210. In associate with port 132, a current limiting resistor 206 may be provided in order to limit the amount of current drawing from port 132 and limit the charging current into power source 130. Circuitry 200 may also control the functioning of indicator 134, which in some embodiments is an LED light. Indicator 134 may be utilized to indicate the on/off activation status of lighter 100. It may also be used to indicate the charge status of power source 130, blinking a designated number of times, for instance, when the device has a lower power available. Indicator 134 may additionally, or alternatively, blink a number of times to indicate when the power source is charging, in embodiments where power source is rechargeable. An additional indicator 160 may be further provided with an independent activation switch 208 with a resistor 212 for limiting current into indicator 208, allowing it to operate within the prescribed voltage of circuitry 200. Indicator 160 may be, for instance, an LED convenience light for illuminating an environmental area near lighter 100, or providing a second status symbol different than a status symbol than indicated by indicator 134.

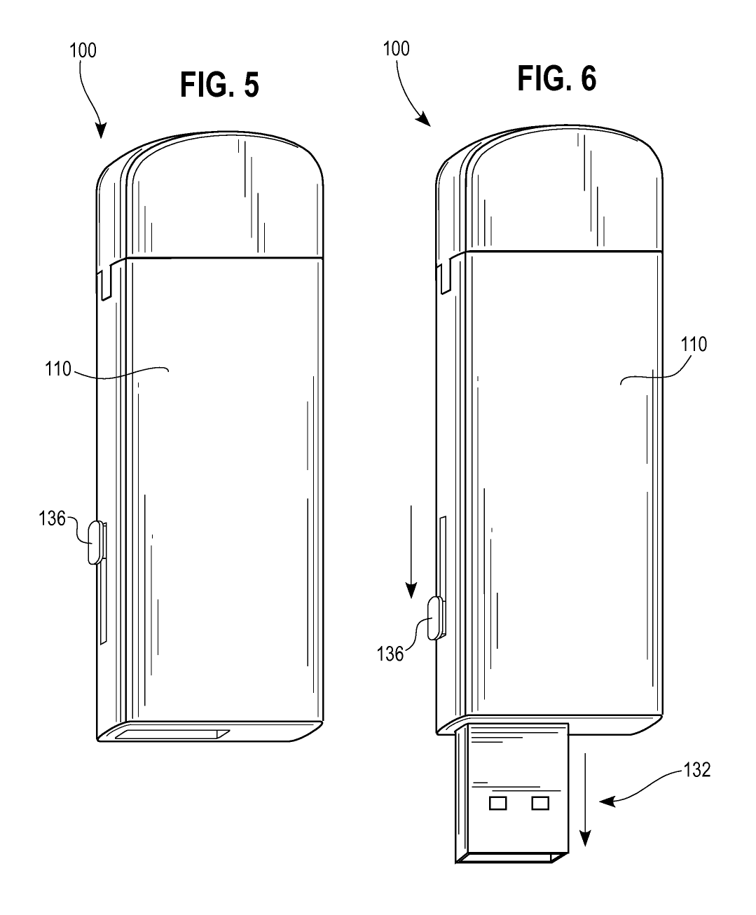

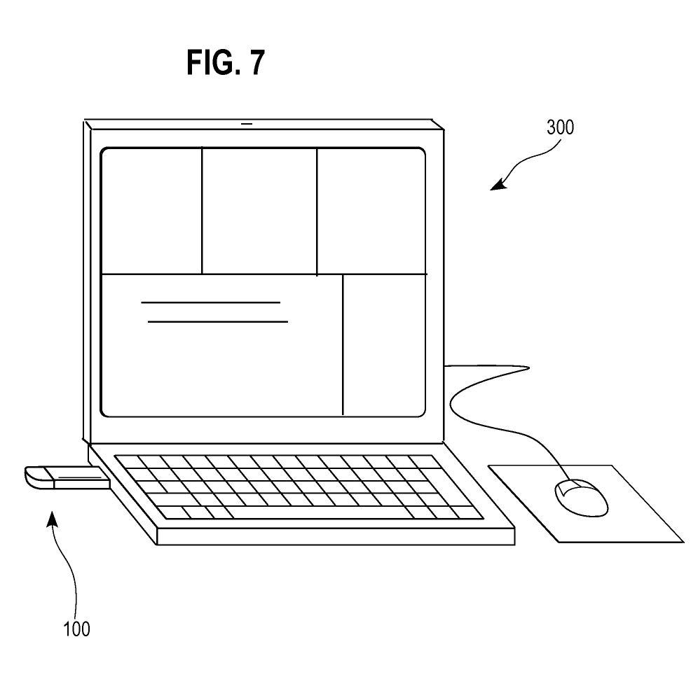

As illustrated in FIGS. 5 and 6, port 132 is retractable between a deployed position and a retracted position in some embodiments, for instance by manipulation of a tab 136 positioned on the side of lighter 100. In the retracted position, port 132, which in the illustrated embodiment is a USB port, is protected or encapsulated by shell 110. In a deployed position, port 132 distends beyond shell 110 so that port 132 may engage of dock with a mating charging station, such as a personal computer 300 as illustrated in FIG. 7. In embodiments of the disclosure featuring a USB port as port 132, a memory feature (not illustrated) may be an included component of light 100. USB ports 132 may, thus, serve a dual function of recharging power source 130, as well as storing digital information transferred from computer 300 during docking.

Additionally incorporated into circuitry 200 is a safety feature of an automatic time out, which will cease electrical current flow to the coil for longer than a predetermined amount of time, which may be approximately ten (10) seconds. This safety feature prevents coil 120 from unintentionally starting a fire should a user, for instance, set lighter 100 down near combustible material in its open or activated position. The time out safety feature further operates to prevent power source 130 from being unintentionally or overly drained. This time out feature may be incorporated into IC 210.

The descriptions set forth above are meant to be illustrative and not limiting, and persons of skill in the art will recognize that various common and known deviations from the above described structures are considered to be within the scope of the disclosed concepts described herein.

### LISTING OF REFERENCES

100 Lighter
110 Shell
112 First End
114 Second End
116 Cap
118 Hinge
120 Coil
130 Power Source
132 USB Port
134 Indicator
136 Tab
140 Printed Circuit Board
150 Switch
160 Indicator
200 Circuitry
202 Capacitor
204 Capacitor
206 Resistor
208 Switch
210 Integrated Circuit
212 Resistor
300 Computer

What is claimed is:

1. A lighter comprising:
a shell having opposed first and second ends;
a power source disposed within the shell;
a coil provided proximate to the first end of the shell, the power source in electrical communication with the coil in order to drive a current through the coil thereby heating the coil; and
a cover positionable proximate to the first end of the shell and movable between a closed position and an open position, the closed position substantially covering the coil from the environment and the open position exposing at least a portion of the coil to the environment thereby permitting a user of the lighter to press a combustible object against the coil in order to ignite the combustible object.

2. The lighter of claim 1, wherein the power source is a rechargeable battery.

3. The lighter of claim 2, further comprising a port provided proximate the second end of the shell and in electrical communication with the rechargeable battery, the port connectable with an exterior power source in order to recharge the recharagable battery.

4. The lighter of claim 3, wherein the port is a USB port and the exterior power source is a personal computer.

5. The lighter of claim 4, further comprising a memory feature for storing digital information from the personal computer through the USB port.

6. The lighter of claim 3, wherein the port is movable between a retracted position and a deployed position, the port disposed within the shell in the retracted position and extending out of and away from the shell in the extend position.

7. The lighter of claim 1, wherein the cover is connected to the shell at a hinge.

8. The lighter of claim 7, further comprising a switch disposed within the shell, the switch operable to drive a current flow from the power source through the coil thereby activating the lighter when the cover is in the open position.

9. The lighter of claim 1, wherein the cover is substantially planar and slidable between the open and closed positions.

10. The lighter of claim 9, further comprising a switch disposed within the shell, the switch operable to drive a current flow from the power source through the coil thereby activating the lighter when the cover is in the open position.

11. The lighter of claim 1, wherein the coil is comprised of a nichrome wire.

12. The lighter of claim 11, wherein the coil glows a red or orange color when the lighter is activated.

13. The lighter of claim 1, further comprising an integrated circuit in electrical communication with the power source and the coil.

14. The lighter of claim 1, further comprising an illuminable indicator in electrical communication with the power source.

15. The lighter of claim 14, wherein the indicator is an LED visible from outside the shell.

16. The lighter of claim 1, wherein the combustible object is a cigarette.
